(19) United States
(12) Patent Application Publication
(10) Pub. No.: US 2012/0180503 A1
(43) Pub. Date: Jul. 19, 2012

(54) CRYOPUMP AND VACUUM VALVE DEVICE

(75) Inventor: Ken Oikawa, Tokyo (JP)

(73) Assignee: SUMITOMO HEAVY INDUSTRIES, LTD., Tokyo (JP)

(21) Appl. No.: 13/351,753

(22) Filed: Jan. 17, 2012

(30) Foreign Application Priority Data
Jan. 17, 2011 (JP) 2011-006768

(51) Int. Cl. B01D 8/00; F16K 17/00

(52) U.S. Cl. 62/55.5; 137/526

(57) ABSTRACT

A cryopump includes: a vent valve provided with a cryopump housing to discharge a gas pumped on a cryopanel to the outside of the cryopump housing; and a control unit configured to determine, based on the pressure measured by a pressure sensor, whether a positive pressure is generated in the cryopump housing relative to the external pressure of the cryopump housing, and configured to open the vent valve when it is determined that the positive pressure is generated, and configured to close the vent valve when it is determined that the positive pressure is not been generated. The valve-closing force of the vent valve is arranged such that, when the vent valve is closed by the control unit, the vent valve can be mechanically opened by being subjected to the differential pressure between the internal pressure and the external pressure of the cryopump housing.

### BACKGROUND

1. Technical Field

The present invention relates to a cryopump and a vacuum valve device preferably used in a vacuum apparatus, such as a cryopump.

2. Description of Related Art

A vacuum valve is provided to be opened or closed in an exhaust channel for evacuating the atmosphere in a vacuum chamber. The exhaust channel is connected to a vacuum pump and the vacuum chamber. The vacuum valve is open when the atmosphere in the vacuum chamber is being evacuated by the vacuum pump. On the other hand, the vacuum valve is closed when the vacuum pump is stopped, to prevent a counter flow of a gas into the vacuum chamber.

### SUMMARY

A cryopump according to an embodiment of the present invention includes: a cryopanel configured to condense or adsorb evacuate a gas to be pumped; a cryopump housing configured to house the cryopanel; a pressure sensor configured to measure an internal pressure of the cryopump housing; a vent valve configured to discharge the gas pumped on the cryopanel to outside of the cryopump housing, the vent valve provided with the cryopump housing; and a control unit configured to determine, based on a pressure measured by the pressure sensor, whether a positive pressure is generated in the cryopump housing relative to an external pressure, the control unit configured to open the vent valve when it is determined that the positive pressure is generated, and configured to close the vent valve when it is determined that the positive pressure is not generated. A valve-closing force of the vent valve is arranged such that, when the vent valve is closed by control of the control unit, the vent valve is capable of being mechanically opened by being subjected to a differential pressure between the internal pressure and the external pressure.

Another embodiment of the present invention is a vacuum valve apparatus in an exhaust channel for releasing a positive pressure in a vacuum vessel to outside. The apparatus includes a normally-closed control valve configured to be controllable to close the exhaust channel when an inside of the vacuum vessel is in a vacuum state and to open the exhaust channel when a measured pressure in the vacuum vessel is over a reference pressure that is higher than an external pressure. A valve-closing force of the control valve is arranged such that, even when the valve is not open by control, the valve is capable of being mechanically opened by being subjected to a differential pressure between the positive pressure and the external pressure.

### BRIEF DESCRIPTION OF THE DRAWINGS

Embodiments will now be described, byway of example only, with reference to the accompanying drawing, which are meant to be exemplary, not limiting, in which:

FIG. 1 is a view schematically illustrating a cryopump according to an embodiment of the present invention;

FIG. 2 is a view schematically illustrating a vacuum evacuation system according to an embodiment of the invention; and

FIG. 3 is a view schematically illustrating a vent valve according to an embodiment of the invention.

### DETAILED DESCRIPTION

The invention will now be described by reference to the preferred embodiments. This does not intend to limit the scope of the present invention, but to exemplify the invention.

A gas entrapment vacuum pump represented by, for example, a cryopump, it performs vacuum pumping by condensing or adsorbing a gas in the pump. The entrapped gas is discharged to the outside of the pump at a certain frequency by a process generally called regeneration. During the regeneration process, the pressure inside the pump is sometimes increased by the revaporization of the gas entrapped therein. Usually, such a high-pressure is appropriately discharged from an exhaust channel.

To avoid that an excessively high pressure may be generated inside, it is required that a safety valve is provided in addition to an ordinary exhaust channel. The pressure is sometimes increased not only during the regeneration process but also with an abnormality or failure in a pump. The safety valve is released when being subjected to an abnormally high pressure, exceeding a normal variation range of the internal pressure. That is, a safety valve is a component that is usually maintained in a closed state and does not operate. It is desirable that the cost of such a component is as low as possible, as long as the component has desired qualities of preventing occurrence of a leak in a closed state, etc.

It is desirable that a vacuum valve by which the function of releasing an excessively high pressure from a vacuum vessel can be achieved at low cost in a vacuum system, and a cryopump provided with such a vacuum valve, are provided.

A cryopump according to an embodiment of the present invention includes: a cryopanel configured to condense or adsorb a gas to be pumped; a cryopump housing configured to house the cryopanel; a pressure sensor configured to measure a pressure in the cryopump housing; a vent valve provided with the cryopump housing to discharge the gas pumped on the cryopanel to the outside of the cryopump housing; and a control unit configured to determine, based on the pressure measured by the pressure sensor, whether a positive pressure has been generated in the cryopump housing relative to the external pressure of the cryopump housing, and configured to open the vent valve when it is determined that the positive pressure has been generated, and configured to close the vent valve when it is determined that the positive pressure has not been generated. The valve-closing force of the vent valve is adjusted such that, when the vent valve is closed by the control unit, the vent valve can be mechanically opened by being subjected to the differential pressure between the internal pressure and the external pressure of the cryopump housing.

According to the embodiment, when a positive pressure is generated in the cryopump housing with respect to the external pressure thereof, the internal pressure can be released to the outside by a control in which the vent valve is opened. Also, when the cryopump is in an abnormal state where the internal pressure is not released by the control, the pressure can be released by mechanically opening the vent valve by being subjected to the differential pressure. By mounting the function of a safety valve to the controlled valve, as stated above, a system can be achieved at low cost in comparison with the case where the respective functions are provided as individual valves in the system.

Another embodiment of the present invention is a vacuum valve device. The device is a vacuum valve device to be provided in an exhaust channel for releasing a positive pressure generated in a vacuum vessel to the outside, wherein the device includes a normally-closed control valve to be controlled so as to close the exhaust channel when the inside of the vacuum vessel is in a vacuum state and to open the exhaust channel when a measured pressure in the vacuum vessel has exceeded a reference pressure higher than the external pressure. The valve-closing force of the control valve is adjusted such that, even when the valve is not released by control, the valve can be mechanically opened by being subjected to the differential pressure between the positive pressure and the external pressure.

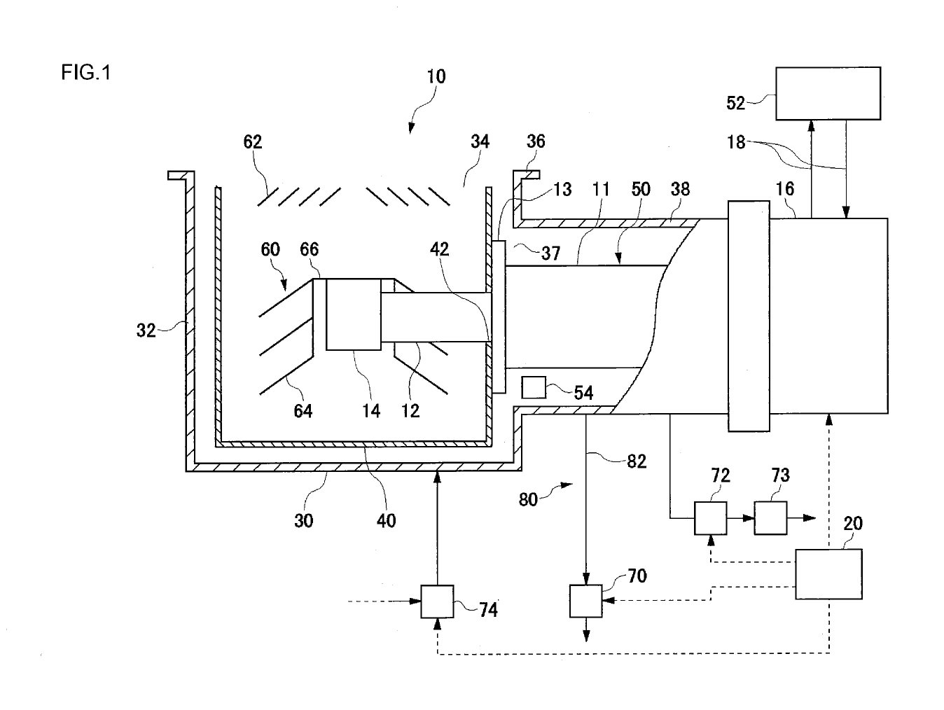

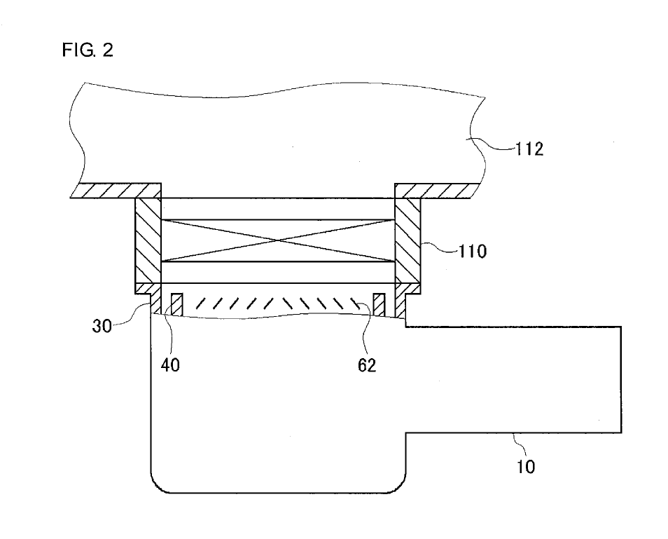

FIG. 1 is a view schematically illustrating a cryopump 10 according to an embodiment of the present invention. FIG. 2 is a view schematically illustrating a vacuum evacuation system including the cryopump 10. The cryopump 10 is mounted to a vacuum chamber 112 (see FIG. 2) of an apparatus, such as an ion implantation apparatus, a sputtering apparatus, or the like, to be used to enhance the degree of vacuum in the vacuum chamber 112 to a level required in a desired process. The cryopump 10 is configured to include a cryopump housing 30, a radiation shield 40, and a refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12. The second cooling stage 14 is installed on the second cylinder 12 at the end that is farthest from the first cylinder 11. The refrigerator 50 illustrated in FIG. 1 is a two-stage refrigerator in which a lower temperature is attained by combining two cylinders in series. The refrigerator 50 is connected to a compressor 52 through a refrigerant pipe 18.

The compressor 52 compresses a refrigerant gas (i.e., an operating gas) such as helium or the like, and supplies the gas to the refrigerator 50 through the refrigerant pipe 18. While cooling the operating gas by allowing the gas to pass through a regenerator, the expansion of the gas in an expansion chamber inside the first cylinder 11 and in an expansion chamber in the second cylinder 12 further cools the refrigerator 50. The regenerator is installed inside the expansion chambers. Thereby, the first cooling stage 13 installed in the first cylinder 11 is cooled to a first cooling temperature level while the second cooling stage 14 installed in the second cylinder 12 is cooled to a second cooling temperature level lower than the first cooling temperature level. For example, the first cooling stage 13 is cooled to approximately 65-100 K while the second cooling stage 14 is approximately 10-20 K.

The operating gas, which has absorbed heat by expanding in the respective expansion chambers and cooled the respective cooling stages, passes through the regenerator again and is returned to the compressor 52 through the refrigerant pipe 18. The flows of the operating gas from the compressor 52 to the refrigerator 50 and from the refrigerator 50 to the compressor 52 are switched by a rotary valve (not illustrated) in the refrigerator 50. A valve drive motor 16 rotates the rotary valve by receiving power from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor (not illustrated) may be provided on the first cooling stage 13 or the second cooling stage 14. The control unit 20 may control the cooling temperature by controlling the driving frequency of the valve drive motor 16. For this purpose, the control unit 20 may be provided with an inverter for controlling the valve drive motor 16. The control unit 20 may be configured so as to control the compressor 52, and valves that will be described later. The control unit 20 may be provided to be integrated with the cryopump 10 or be configured as a controller separate from the cryopump 10.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually orthogonally) with the axis of the cylindrical radiation shield 40. The present invention is also applicable to a so-called vertical-type cryopump in a similar way. In the vertical-type cryopump, the refrigerator is inserted along the axis of the radiation shield.

The cryopump housing 30 has a portion 32 formed into a cylindrical shape (hereinafter, referred to as a “trunk portion”), one end of which is provided with an opening and the other end is closed. The opening is provide as an inlet 34 through which a gas to be evacuated from the vacuum chamber (see FIG. 2) of e.g., a sputtering apparatus enters. The inlet 34 is defined by the inner surface of the upper end of the trunk portion 32 of the cryopump housing 30. In the trunk portion 32 also is formed an opening 37 for inserting the refrigerator 50, in addition to the opening as the inlet 34. One end of a cylindrically-shaped refrigerator container 38 is fitted to the opening 37 of the trunk portion 32 while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted to the vacuum chamber 112 (see FIG. 2), a volume to be pumped, of a sputtering apparatus, etc., by using the mounting flange 36.

The cryopump housing 30 is provided in order to separate the inside of the cryopump 10 from the outside thereof. As described above, the cryopump housing 30 is configured to include the trunk portion 32 and the refrigerator container 38, and the trunk portion 32 and the refrigerator container 38 are maintained to be airtight such that the respective insides thereof have a common pressure. Thereby, the cryopump housing 30 functions as a vacuum vessel during the vacuum pumping operation of the cryopump 10. Because the outer surface of the cryopump housing 30 is exposed to the environment outside the cryopump 10 during the operation of the cryopump 10, i.e., even during the operation of the refrigerator, the outer surface is maintained at a temperature higher than that of the radiation shield 40. The temperature of the cryopump housing 30 is typically maintained at an ambient temperature. Herein, the ambient temperature refers to a temperature of a place where the cryopump 10 is installed or a temperature close to the temperature. The ambient temperature may be, for example, at or around room temperature.

A pressure sensor 54 is provided in the refrigerator container 38 of the cryopump housing 30. The pressure sensor 54 periodically measures the internal pressure of the refrigerator container 38, i.e., the pressure in the cryopump housing 30 and outputs a signal indicating the measured pressure to the control unit 20. The pressure sensor 54 is connected to the control unit such that the output thereof can be communicated. Alternatively, the pressure sensor 54 may be provided in the trunk portion 32 of the cryopump housing 30.

The pressure sensor 54 has a wide measurement range including both a high vacuum level attained by the cryopump 10 and the atmospheric pressure level. It is desirable that at least a pressure range, which can be generated during a regeneration process, is included in the measurement range. In the present embodiment, it is preferable to use, for example, a crystal gauge as the pressure sensor 54. The crystal gauge refers to a sensor that measures a pressure by using a phenomenon in which the oscillation resistance of a crystal oscillator varies with a pressure. Alternatively, the pressure sensor 54 maybe a Pirani gauge. A pressure sensor for measuring a vacuum level and that for measuring an atmospheric pressure level may be individually provided in the cryopump 10.

A vent valve 70, a rough valve 72 and a purge valve 74 are connected to the cryopump housing 30. The opening/closing of each of the vent valve 70, rough valve 72, and purge valve 74 are controlled by the control unit 20.

The vent valve 70 is provided, for example, at the end of an exhaust line 80. Alternatively, the vent valve 70 may be provided in the middle of the exhaust line 80 and a tank or the like for collecting discharged fluid may be provided at the end of the exhaust line 80. Alternatively, the vent valve 70 may be connected to an evacuation system attached to the vacuum chamber 112 (see FIG. 2) to which the cryopump 10 is to be connected.

By the opening of the vent valve 70, the flow of fluid in the exhaust line 80 is permitted, and by the closing of the vent valve 70, the flow of the fluid in the exhaust line 80 is blocked. Although the fluid to be exhausted is basically a gas, the fluid may be a liquid or a mixture of gas-liquid. For example, liquefied gas that has been condensed by the cryopump 10 may be mixed with the fluid to be exhausted. By the opening of the vent valve 70, the positive pressure generated in the cryopump housing 30 can be released to the outside.

The exhaust line 80 includes an exhaust duct 82 for exhausting fluid from the internal space of the cryopump 10 to an external environment. The exhaust duct 82 is connected to, for example, the refrigerator container 38 in the cryopump housing 30. Although the exhaust duct 82 is a duct having a circular cross section orthogonal to the direction of the flow, the exhaust duct 82 may have a cross section of any other shapes . The exhaust line 80 may include a filter for removing foreign bodies from the fluid to be exhausted through the exhaust duct 82. The filter may be provided upstream from the vent valve 70 in the exhaust line 80.

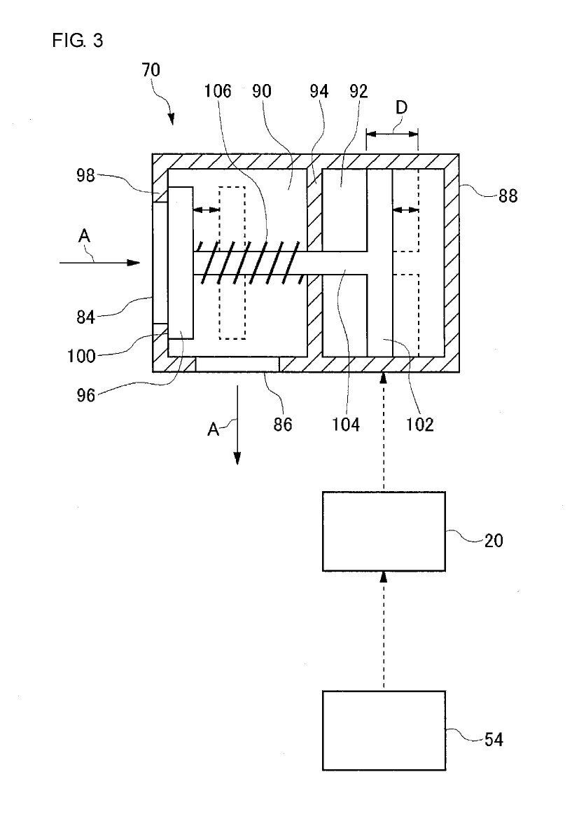

The vent valve 70 is configured to function as a so-called safety valve. The vent valve 70 is, for example, a normally-closed control valve that is provided in the exhaust duct 82. Further, the valve-closing force of the vent valve 70 is set in advance such that the vent valve 70 can be mechanically opened when being subject to a predetermined differential pressure. The preset differential pressure can be appropriately set by taking into consideration, for example, the internal pressure that can be exerted upon the cryopump housing 30 and the structural durability of the cryopump housing 30, etc. Because the external environment of the cryopump 10 is normally at the atmospheric pressure, the preset differential pressure is set to a predetermined pressure relative to the atmospheric pressure. The setting of the valve-closing force of the vent valve 70 will be described in detail with reference to FIG. 3.

The vent valve 70 is opened by the control unit 20 when fluid is discharged from the cryopump 10, for example, during a regeneration process. When fluid should not be discharged, the vent valve 70 is closed by the control unit 20. On the other hand, the vent valve 70 is mechanically opened when the preset differential pressure is exerted thereon. As a result, when the internal pressure of the cryopump rises too high for some reasons, the vent valve 70 is opened mechanically without requiring control. Thereby, the internal high pressure can be released. Thus, the vent valve 70 functions as a safety valve. By making the vent valve 70 also have the function of a safety valve in this way, advantages of cost reduction and space saving can be achieved in comparison with the case where two valves are separately provided.

The rough valve 72 is connected to a roughing pump 73. The roughing pump 73 and the cryopump 10 are communicated with or blocked from each other by the opening/closing of the rough valve 72. The roughing pump 73 is typically provided as a vacuum apparatus separate from the cryopump 10, and forms, for example, part of a vacuum system including the vacuum chamber 112 to which the cryopump 10 is connected. The purge valve 74 is connected to a non-illustrated purge gas supply apparatus . A purge gas is, for example, a nitrogen gas. The control unit 20 controls the purge valve 74, thereby allowing the supply of the purge gas to the cryopump 10 to be controlled.

The radiation shield 40 is arranged inside the cryopump housing 30. The radiation shield 40 is formed into a cylindrical shape, one end of which is provided with an opening and the other end is closed, that is, a cup-like shape. The radiation shield 40 may be formed into an integrated tubular shape as illustrated in FIG. 1, or may be formed to have a tubular shape as a whole by a plurality of parts. The plurality of parts may be arranged so as to have a gap between one and another.

The trunk portion 32 of the cryopump housing 30 and the radiation shield 40 are both formed into approximately cylindrical shapes and are arranged concentrically. The inner diameter of the trunk portion 32 of the cryopump housing 30 is slightly larger than the outer diameter of the radiation shield 40. Therefore, the radiation shield 40 is arranged in non-contact with the cryopump housing 30, i.e., in a state of having a slight gap with the inner surface of the trunk portion 32 of the cryopump housing 30. That is, the outer surface of the radiation shield 40 faces the inner surface of the cryopump housing 30. The shapes of the trunk portion 32 of the cryopump housing 30 and the radiation shield 40 are not limited to a cylindrical shape, but may be a tubular shape having any cross section, such as a rectangular tube shape or elliptical tube shape. Typically, the shape of the radiation shield 40 is made to be analogous to the shape of the inner surface of the trunk portion 32 of the cryopump housing 30.

The radiation shield 40 is provided as a radiation shield to protect both the second cooling stage 14 and a low-temperature cryopanel 60, which is thermally connected to the second cooling stage 14, from the radiation heat mainly from the cryopump housing 30. The second cooling stage 14 is arranged substantially on the central axis of the radiation shield 40 in the radiation shield 40. The radiation shield 40 is fixed to the first cooling stage 13 in a thermally connected state, so that the radiation shield 40 is cooled to a temperature almost the same as that of the first cooling stage 13.

The low-temperature cryopanel 60 includes, for example, a plurality of panels 64. Each of the panels 64 has the shape of the side surface of a truncated cone, i.e., a so-called umbrella-like shape. Each panel 64 is attached to a panel mounting member 66 that is fixed to the second cooling stage 14. An adsorbent (not illustrated), such as activated carbon, is typically provided on each panel 64. The adsorbent is adhered to, for example, the back surface of the panel 64.

The panel mounting member 66 has a cylindrical shape, one end of which is closed and the other end is open. The closed end portion of the member is mounted at the upper end of the second cooling stage 14, and the cylindrical side surface of the member extends toward the bottom of the radiation shield 40 so as to surround the second cooling stage 14. The plurality of the panels 64 are attached to the cylindrical side surface of the panel mounting member 66 with a gap between one and another. An opening for inserting the second cylinder 12 of the refrigerator 50 is formed on the cylindrical side surface of the panel mounting member 66.

A baffle 62 is provided in the inlet of the radiation shield 40 in order to protect both the second cooling stage 14 and the low-temperature cryopanel 60, which is thermally connected to the stage, from the radiation heat emitted from the vacuum chamber 112, etc. The baffle 62 is formed into, for example, a louver structure or a chevron structure. The baffle 62 may be formed into a concentric circle shape whose center is the central axis of the radiation shield 40, or may be formed into another shape such as a lattice-like shape. The baffle 62 is mounted at the opening end of the radiation shield 40 and cooled to a temperature almost the same as that of the radiation shield 40.

A refrigerator mounting hole 42 is formed on the side surface of the radiation shield 40. The refrigerator mounting hole 42 is formed at the middle part of the side surface of the radiation shield 40 with respect to the central axis of the radiation shield 40. The refrigerator mounting hole 42 of the radiation shield 40 is provided coaxially with the opening 37 of the cryopump housing 30. The second cylinder 12 and the second cooling stage 14 of the refrigerator 50 are inserted through the refrigerator mounting hole 42 along the direction perpendicular to the central axis of the radiation shield 40. The radiation shield 40 is fixed to the first cooling stage 13 at the refrigerator mounting hole 42 so as to be thermally connected to the stage.

As an alternative to the direct mounting of the radiation shield 40 to the first cooling stage 13, the radiation shield 40 may be mounted to the first cooling stage 13 by a connecting sleeve. The sleeve is, for example, a heat transfer member for surrounding one end of the second cylinder 12 near to the first cooling stage 13 and for thermally connecting the radiation shield 40 to the first cooling stage 13.

As illustrated in FIG. 2, a gate valve 110 may be provided between the baffle 62 and the vacuum chamber 112. The gate valve 110 is made to be closed, for example, when the cryopump 10 is regenerated, while made to be opened when the vacuum chamber is evacuated by the cryopump 10. When the gate valve 110 is being opened, the vacuum chamber 112 and the cryopump housing 30 form a single vacuum vessel, and when the gate valve 110 is being closed, the cryopump housing 30 forms a vacuum vessel different from the vacuum chamber 112.

FIG. 3 is a view schematically illustrating the vent valve 70 according to an embodiment of the present invention. The vent valve 70 blocks the flow from a vacuum port 84 to an exhaust port 86 in the closed state illustrated in FIG. 3. On the other hand, the vent valve 70 permits an exhaust flow from the vacuum port 84 to the exhaust port 86 in the open state. The exhaust flow is illustrated by Arrow A in FIG. 3. The position of a valve body in the open state is illustrated by the dashed lines. Although the vent valve 70 allows the opposite flow to the exhaust flow A illustrated in FIG. 3, in an embodiment in which the vent valve 70 is applied to the cryopump 10, the vent valve 70 operates so as to permit only the exhaust flow A.

The vent valve 70 is configured to include a valve chest 90 and a piston box 92 that are divided from the outside by a valve housing 88. The valve chest 90 and the piston box 92 are adjacent to each other and divided from each other by a partition plate 94. The partition plate 94 is an interior wall of the valve chest 90 that faces the vacuum port 84. Two openings are provided in the valve chest 90, one of which is the aforementioned vacuum port 84 and the other is the exhaust port 86.

The exhaust flow A that has flowed in the valve chest 90 through the vacuum port 84 is bent perpendicularly inside the valve chest 90 to flow out through the exhaust port 86. The vacuum port 84 is connected to the cryopump housing 30 through the exhaust duct 82 (see FIG. 1). The exhaust port 86 may be connected to a pipe for guiding the exhaust flow A to the outside, or may be open directly to the external environment.

A valve plate 96, as the valve body of the vent valve 70, is housed in the valve chest 90. The outside dimension of the valve plate 96 is made to be larger than that of the opening of the vacuum port 84, so that the periphery of the valve plate 96 can be pressed to the surrounding portion 98 of the vacuum port 84. For example, the valve plate 96 and the vacuum port 84 are both formed into concentric circular shapes, and the diameter of the valve plate 96 is made larger than that of the vacuum port 84. The area (e.g., a circular area) in which the periphery of the valve plate 96 is pressed to the surrounding portion of the vacuum port 84 functions as a sealing surface 100. An O-ring for sealing (not illustrated) is provided on the sealing surface 100. The O-ring is housed in, for example, a groove formed within the sealing surface 100 of the valve plate 96.

A piston 102, part of the valve drive mechanism of the vent valve 70, is housed in the piston box 92. The piston 102 is supported such that the side surface thereof is slidable on the interior wall of the piston box 92. The piston box 92 is divided into two portions by the piston 102. The piston 102 is connected to the valve plate 96 by a connecting shaft 104. The connecting shaft 104 is a rod-shaped member that perpendicularly extends from the center of the surface, opposite to the sealing surface 100, of the valve plate 96 and the shaft 104 is fixed to the piston 102. The connecting shaft 104 penetrates the partition plate 94 and is supported by, for example, a bearing (not illustrated) at the through-hole such that the shaft is movable in the shaft direction. Accordingly, the piston 102 is slidable in the shaft direction of the connecting shaft 104 along the interior wall of the piston box 92. By being fixed with the connecting shaft 104, the valve plate 96 is movable in the shaft direction integrally with the piston 102.

The valve drive mechanism is, for example, a compressed air drive mechanism. That is, the piston 102 is driven by supplying compressed air to the piston box 92. The valve drive mechanism may also include an electromagnetic valve for switching supply and supply stop of the compressed air to the piston box 92. A compressed air supply port and an exhaust port are provided in one of the two portions of the piston box 92 divided by the piston 102, and these supply port and exhaust port are connected to a compressed air supply system including the aforementioned electromagnetic valve. The control unit 20 controls the opening/closing of the electromagnetic valve. When the electromagnetic valve is opened, compressed air is supplied to the piston box 92 to move the piston 102 from an initial position. When the electromagnetic valve is closed, the compressed air is discharged from the piston box 92 to return the piston 102 to the initial position by an operation of a spring 106, described below.

The valve drive mechanism may be any other type of drive mechanism. For example, it maybe a so-called direct drive type in which the piston 102 is directly driven by a solenoidal electromagnetic force of attraction, or may be a type in which the valve body is driven by an appropriate motor, such as a linear motor, a stepping motor, or the like.

The vent valve 70 is provided with a valve-closing mechanism including the spring 106. The spring 106 is provided to press the periphery of the valve plate 96 onto the surrounding portion 98 of the vacuum port 84 in order to exert a sealing pressure to the sealing surface 100. The spring 106 biases the valve plate 96 in the direction opposite to the exhaust flow A that flows in through the vacuum port 84. One end of the spring 106 is attached to the surface of the valve plate 96, opposite to the sealing surface 100 thereof, and the other end is attached to the partition plate 94. The spring 106 is provided along the connecting shaft 104. Thus, the vent valve 70 is configured as a normally-closed control valve.

The spring 106 is mounted with a mounting preload of a predetermined compressive force, and the mounting load defines the valve-closing force of the vent valve 70. That is, when a differential pressure force exerted on the valve plate 96 by a differential pressure exceeds the spring mounting preload, i.e., the valve-closing force, the valve plate 96 is moved to some extent by the differential pressure, thereby allowing the vent valve 70 to be opened. The flow from the vacuum port 84 to the exhaust port 86 is permitted by this mechanical opening of the valve. In a usual use of the vacuum chamber 112 (see FIG. 2), the vent valve 70 is never mechanically opened because the pressure on the vacuum side is lower than that on the exhaust side and the spring 106 biases the valve plate 96 toward the vacuum port 84. In an exceptional situation in which the pressure on the vacuum port 84 side is higher than that on the exhaust port 86 side, the vent valve 70 can be mechanically opened.

The valve-closing mechanism of the vent valve 70 is not limited to a spring type. For example, a valve-closing mechanism by a magnetic force may be adopted. A desired valve-closing force maybe provided by fixing the valve plate 96 to the surround portion of the vacuum port 84 with a magnetic attractive force. In this case, a magnet for exerting an attractive force between the valve plate 96 and the surrounding portion 98 of the vacuum port 84 is provided in at least one of the two components 96, 98. Alternatively, a valve-closing mechanism by electrostatic clamping or other proper valve-closing mechanism may be adopted.

The vent valve 70 is a control valve controlled by the control unit 20 based on the results of measurement by the pressure sensor 54. The control unit 20 determines whether the internal pressure of the cryopump housing 30 measured by the pressure sensor 54 exceeds a reference pressure. When it is determined that the internal pressure exceeds the reference pressure, the control unit 20 opens the vent valve 70 by a valve drive mechanism. That is, the control unit 20 moves the piston 102 and the valve plate 96 from the position where the valve is closed (hereinafter, it maybe referred to as the closed position or initial position) to the position where the valve is opened (hereinafter, it may be referred to as the open position). In FIG. 3, the closed position is illustrated by the solid lines, while the open position is illustrated by the dashed lines.

On the other hand, when it is determined that the internal pressure of the cryopump housing 30 measured by the pressure sensor 54 does not reach the reference pressure, the control unit 20 maintains the piston 102 and the valve plate 96 at the closed position. In this case, the control unit 20 does not operate the valve drive mechanism, and hence the piston 102 and the valve plate 96 are maintained at the closed position by the valve-closing force of the spring 106.

The reference pressure for controlling the opening/closing of the vent valve 70 is set to the pressure of the external environment of the cryopump 10. Alternatively, when considering it to be important that a counter flow from the outside of the pump to the inside thereof, occurring when the vent valve 70 has been opened, is surely prevented, the reference pressure is set to be slightly higher than the pressure of the exterior environment. That is, the control unit 20 determines whether a positive pressure is generated inside the cryopump 30 with respect to the external pressure of the cryopump housing 30 based on the pressure measured by the pressure sensor 54. When it is determined that a positive pressure is generated, the control unit opens the vent valve 70, and when it is determined that a positive pressure is not generated, the control unit closes the vent valve 70. As stated above, when the internal pressure of the cryopump 10 becomes higher than the external pressure during, for example, a regeneration process, the vent valve 70 is opened by the control, thereby allowing the internal pressure to be released to the outside.

In view of the fact that the pressure of the external environment is typically the atmospheric pressure, the reference pressure for controlling the opening/closing of the vent valve 70 is set to the atmospheric pressure or a pressure slightly higher than that (e.g., higher than by 0.1 atm or less as a gauge pressure).

A control valve is usually configured such that, in a circumstance in use, an open state (or a closed state) of the valve is surely maintained when the valve should be open (or closed) by control. In order to prevent a normally-closed control valve from being accidentally opened in an expected range of differential pressure to be exerted on the valve in the closed state, its valve-closing force is defined to be greater than the maximum of the differential pressure range.

In the vent valve 70 according to the present embodiment, the valve closing force is however adjusted such that the valve can be mechanically opened within the pressure range. The valve-closing force of the vent valve 70 is adjusted such that, when the control unit 20 closes the vent valve 70, the valve is mechanically opened by being subjected to the differential pressure between the positive pressure generated in the cryopump housing 30 and the external pressure. Specifically, the valve-closing force of the vent valve 70 is adjusted such that the valve is mechanically opened at a preset differential pressure over the expected differential pressure during a normal operation of the cryopump 10. The normal operation herein includes both a pumping operation and a regeneration operation of the cryopump 10. The vent valve 70 is mechanically opened, for example, when the control system of the valve 70 itself is in an abnormal state or when the internal pressure of the cryopump housing 30 is excessively increased by some factors.

The vent valve 70 is adjusted so as to be mechanically opened when the internal pressure of the cryopump housing 30 reaches a preset pressure between a predefined maximum internal pressure of the housing 30 and the atmospheric pressure. To prevent the mechanical opening of the vent valve 70 during the control, it is preferable that the preset pressure is high than the aforementioned reference pressure of the determination. The preset pressure is selected from a range of 1 to 2 atm, preferably from a range of 1 to 1.5 atm, and more preferably from a range of 1.2 to 1.3 atm. In terms of a gauge pressure, the valve-closing force of the vent valve 70 is adjusted, in design, to be mechanically opened when the valve is subjected to a differential pressure that is 1 atm or less, preferably 0.5 atm or less, and more preferably within a range of 0.2 to 0.3 atm. By adjusting the valve-closing force in this way, the internal pressure of the cryopump housing 30 can be released to the outside through the vent valve 70, before the internal pressure reaches the withstand pressure of the housing 30 or the withstand pressure of the gate valve 110 installed between the housing 30 and the vacuum chamber 112 to be pumped by the cryopump 10.

The opening/closing stroke D of the valve body of the vent valve 70, controlled by the control unit 20, is made to be larger than the valve body movement amount in the mechanical opening of the valve by being subjected to the differential pressure. That is, the vent valve 70 is configured such that the opening/closing stroke D by the valve drive mechanism is larger than the movement amount of the valve plate 96 in a steady state, occurring when being subjected to the aforementioned preset pressure. The valve drive mechanism is configured such that the valve plate 96 is moved with a relatively large stroke in the controlled opening/closing. By configuring the valve drive mechanism in this way, the risk that the foreign particles included in the exhaust flow A may be caught during the opening/closing of the vent valve 70 in a usual control state can be reduced in comparison with the case where the opening/closing stroke is minute. Accordingly, the sealing property of the vent valve 70 can be maintained to be good.

The operations of the cryopump 10 with the aforementioned configuration will be described below. In operating the cryopump 10, the inside of the cryopump housing 30 is first roughly evacuated to approximately 1 Pa by the roughing pump 73 through the rough valve 72 before starting the operation. The pressure is measured by the pressure sensor 54. Thereafter, the cryopump 10 is operated. By driving the refrigerator 50, the first cooling stage 13 and the second cooling stage 14 are cooled under the control of the control unit 20, thereby the radiation shield 40, the baffle 62, and the cryopanel 60, which are thermally connected to the stages, are also cooled.

The cooled baffle 62 cools the gas molecules flying from the vacuum chamber towards the cryopump 10 such that a gas whose vapor pressure is sufficiently low at the cooling temperature (e.g., water vapor or the like) will be condensed on the surface of the baffle 62 and evacuated, accordingly. A gas whose vapor pressure is not sufficiently low at the cooling temperature of the baffle 62 enters into the radiation shield 40 through the baffle 62. Of the entered gas molecules, a gas whose vapor pressure is sufficiently low at the cooling temperature of the cryopanel 60 will be condensed on the surface of the cryopanel 60 and evacuated, accordingly. A gas whose vapor pressure is not sufficiently low at the cooling temperature (e.g., hydrogen or the like) is adsorbed by an adsorbent, which is adhered to the surface of the cryopanel 60 and thus cooled, and the gas is evacuated accordingly. In this way, the cryopump 10 can attain a desired degree of vacuum in the vacuum chamber.

The cryopump 10 illustrated in FIG. 1 alternately repeats a pumping process and a regeneration process. In the pumping process, the gate valve 110 is opened to evacuate the atmosphere in the vacuum chamber 112, thereby allowing the degree of vacuum to be enhanced to a desired level. By continuing the pumping process, captured gases are accumulated on the cryopanel 60. Accordingly, in order to discharge the accumulated ice or the adsorbed gas molecules to the outside, the cryopump 10 is regenerated when a predetermined regeneration start condition is satisfied, for example, when a predetermined period of time has elapsed after the start of the exhaust process. The regeneration process is performed after the gate valve 110 is closed and the cryopump 10 is separated from the vacuum chamber 112.

For example, by introducing a purge gas through the purge valve 74, the temperature of the cryopanel is increased to a regeneration temperature higher than the temperature of the cryopanel during the pumping process, thereby allowing the gases captured on the surface thereof to be revaporized. Accordingly, the pressure in the cryopump housing 30 is likely to be higher than the external atmospheric pressure by some extent. It is more reasonable to evacuate the gases to the outside by using such a positive pressure than to always utilize a vacuum evacuation system such as the roughing pump 73.

Accordingly, the control unit 20 determines whether a positive pressure is generated within the cryopump housing relative to the outside of the cryopump housing based on the pressure measured by the pressure sensor 54, and when it is determined that a positive pressure is generated, the control unit 20 opens the vent valve 70. Thereby, the high-pressure in the cryopump 10 can be released to the outside through the exhaust line 80. When it is determined that a positive pressure is not generated, the control unit 20 closes the vent valve 70. Thus, leak of a gas into the housing is sealed when the pressure in the housing is reduced.

When most of the gases to be discharged in the regeneration process has been discharged through the vent valve 70, the internal pressure of the cryopump 10 is reduced towards the atmospheric pressure level, the amount of the gases from the vent valve 70 is reduced. The control unit closes the vent valve 70 and switches to the roughing through the rough valve 72. After the internal pressure of the cryopump 10 is sufficiently reduced, the cryopanel 60 is cooled by the refrigerator 50 under the control of the control unit 20, and the pumping process is resumed in the same way as what has been described above.

In an embodiment, the control unit 20 may close the vent valve 70 at the same time when the rough valve is opened in a regeneration process. Alternatively, the control unit 20 may be configured to close the vent valve 70 immediately before the rough valve 72 is opened. That is, the control unit 20 may control both the vent valve 70 and the rough valve 72 in the sequential order of a command of closing the vent valve 70 and a command of opening the rough valve 72. By configuring the control unit 20 in such a way, a counter flow from the outside through the vent valve 70, occurring when the rough valve 72 is opened in the closing stage of the regeneration process, can be surely prevented.

According to the present embodiment, the vent valve 70 functions also as a safety valve. When a high pressure is generated in the cryopump 10, the vent valve 70 is mechanically opened by the differential pressure relative to the external pressure. As stated above, the internal pressure of the cryopump 10 can be released to the outside by the opening/closing control of the vent valve 70 in a normal state, and further by the mechanical opening of the valve as a safety valve in an abnormal state. It becomes possible to install a safety valve into the cryopump 10 at low cost in comparison with the case where a control valve and a safety valve for discharge, are separately provided. Also, the vent valve 70 is configured such that the opening/closing stroke of the valve is larger than the valve body movement amount in the mechanical opening of the valve. By configuring the vent valve to have a sufficient opening degree in this way, it can be suppressed that the vent valve 70 may catch foreign substances or be clogged therewith during an opening/closing control of the valve.

In the aforementioned embodiment, an example in which a control valve according to an embodiment of the present invention is applied to the cryopump 10 has been described, the objects to which the control valve is to be applied are not limited to the cryopump 10, and the control valve can also be applied to other vacuum apparatuses each including a gas entrapment vacuum pump other than a cryopump.

Accordingly, the control valve according to the present embodiment may be a vacuum apparatus provided in an exhaust channel for releasing a positive pressure generated in a vacuum vessel to the outside. The control valve may be a normally-closed control valve to be controlled so as to close the exhaust channel when the inside of a vacuum vessel is in a vacuum state and to open the exhaust channel when a measured pressure in the vacuum vessel exceeds a reference pressure higher than the external pressure. The valve-closing force of the control valve may be adjusted such that, even when the valve is not open by control, the valve can be mechanically opened by being subjected to the differential pressure between the positive pressure in the vacuum vessel and the external pressure. That is, the valve-closing force of the control valve is adjusted such that, when the valve is closed, the valve can be mechanically opened by being subjected to the differential pressure between the positive pressure in the vacuum vessel and the external pressure.

In this case, the control valve may be adjusted so as to be mechanically opened when the internal pressure of the vacuum vessel reaches a preset pressure between the predefined maximum internal pressure of the vacuum vessel and the atmospheric pressure. Also, the control valve may be configured such that, when the valve is controlled, the opening/closing stroke of the valve body of the valve is larger than the valve body movement amount in the mechanical opening of the valve by being subjected to the differential pressure.

It should be understood that the invention is not limited to the above-described embodiment, but may be modified into various forms on the basis of the spirit of the invention.

Additionally, the modifications are included in the scope of the invention.

Priority is claimed to Japanese Patent Application No. 2011-6768, filed Jan. 17, 2011, the entire content of which is incorporated herein by reference.

What is claimed is:

1. A cryopump comprising:
a cryopanel configured to condense or adsorb a gas to be pumped;
a cryopump housing configured to house the cryopanel;
a pressure sensor configured to measure an internal pressure of the cryopump housing;
a vent valve configured to discharge the gas pumped on the cryopanel to outside of the cryopump housing, the vent valve provided with the cryopump housing; and
a control unit configured to determine, based on a pressure measured by the pressure sensor, whether a positive pressure is generated in the cryopump housing relative to an external pressure, the control unit configured to open the vent valve when it is determined that the positive pressure is generated, and configured to close the vent valve when it is determined that the positive pressure is not generated,
wherein a valve-closing force of the vent valve is arranged such that, when the vent valve is closed by control of the control unit, the vent valve is capable of being mechanically opened by being subjected to a differential pressure between the internal pressure and the external pressure.

2. The cryopump according to claim 1, wherein
the vent valve is arranged so as to be mechanically opened when the internal pressure reaches a preset pressure between a predefined maximum internal pressure of the cryopump housing and an atmospheric pressure.

3. The cryopump according to claim 2, wherein
the preset pressure is selected from a range of 1 to 1.5 atm.

4. The cryopump according to claim 1, wherein
a stroke for opening and closing a valve body of the vent valve, by control of the control unit, is configured to be larger than a mechanical movement of the valve body for opening under the differential pressure.

5. The cryopump according to claim 1 further comprising a rough valve provided in a channel for connecting the cryopump housing to a roughing pump,
wherein, during a regeneration process of the cryopump, the control unit is configured to simultaneously perform closing of the vent valve and opening of the rough valve.

6. A vacuum valve apparatus in an exhaust channel for releasing a positive pressure in a vacuum vessel to outside, comprising:
a normally-closed control valve configured to be controllable to close the exhaust channel when an inside of the vacuum vessel is in a vacuum state and to open the exhaust channel when a measured pressure in the vacuum vessel is over a reference pressure that is higher than an external pressure,
wherein a valve-closing force of the control valve is arranged such that, even when the valve is not open by control, the valve is capable of being mechanically opened by being subjected to a differential pressure between the positive pressure and the external pressure.
